(19) United States
(12) Patent Application Publication
(10) Pub. No.: US 2024/0149263 A1
(43) Pub. Date: May 9, 2024

(54) ADAPTIVE DESCALING USING LOCATION DATA

(71) Applicant: Haier US Appliance Solutions, Inc., Wilmington, DE (US)

(72) Inventors: Hye-Soo An, Seoul (KR); Taehyun Yoon, Gwangju-si (KR); Je Kwon Yoon, Hwaseong-si (KR)

(21) Appl. No.: 17/983,080

(22) Filed: Nov. 8, 2022

(51) Int. Cl. B01J 49/75; B01J 49/85; C02F 5/02

(52) U.S. Cl. CPC B01J 49/75; B01J 49/85; C02F 5/02

(57) ABSTRACT

A water heating appliance and a method of operating a water heating appliance having a controller and an input device are provided. The controller is configured to obtain location information for the location of the water heating appliance from a user input on the input device or from data transfer from the water heating appliance and determine the water hardness from the location information. The controller determines a descaling schedule for the water heating appliance from the water hardness.

### FIELD OF THE INVENTION

The present disclosure relates generally to water heating appliances that include a descaling feature, and more particularly to hot brewed coffee makers.

### BACKGROUND OF THE INVENTION

Water heating appliances, for example coffee makers, have become common household appliances. Typical water heating appliances include a reservoir for storing a quantity of water provided from a water source, commonly a water utility or a private well. The stored water is heated by a heating element, typically an electric resistance heating element, to a prescribed temperature prior to being introduced to a quantity of ground coffee to brew an amount of coffee.

Depending on the geographical area, the water supplied to the water heating appliance may have various concentrations of dissolved minerals, for example calcium and magnesium. The concentration of minerals varies with location, with some areas having a high concentration (i.e., hard water) while other areas have a low concentration (i.e., soft water) and still other areas having mineral concentrations between the extremes. These minerals pass through the water heating appliance and eventually form deposits, known as scale, on components of the appliance. The amount of scale that forms is proportional to the concentration of minerals in the water and the amount of water processed by the water heating appliance. Some water heating appliances alert a user that a descaling operation is required, usually after a prescribed amount of time has elapsed, for example the amount of time the heater element is energized. Typical water heating appliances do not take into account the concentration of minerals in the water when alerting the user to perform a descaling operation. In areas where the water supply is soft, the user may be alerted to perform the descaling operation more frequently than necessary. In areas with hard water, the user may not receive a descaling alert as frequently as necessary.

Accordingly, improvements to the descaling schedule for water heating appliances based on location are desirable.

### BRIEF DESCRIPTION OF THE INVENTION

Aspects and advantages of the invention will be set forth in part in the following description, may be apparent from the description, or may be learned through practice of the invention.

In one exemplary aspect, a method of operating a water heater appliance is provided for a water heater appliance having a controller and an input device. The method includes obtaining a water hardness at the location of the water heating appliance, classifying the water hardness in one class of a plurality of classes of water hardness, and determining a descaling schedule for the water heating appliance from the class of water hardness.

In another example aspect, a water heating appliance is provided, the water heating appliance having a controller and an input device. The controller is configured to obtain location information for the location of the water heating appliance from a user input on the input device or from data transfer from the water heating appliance and determine the water hardness from the location information. The controller classifies the water hardness into one class of a plurality of classes of water hardness and determine a descaling schedule for the water heating appliance from the one class of water hardness.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a partially exploded perspective view of an exemplary water heating appliance according to an embodiment of this disclosure; and

FIG. 2. provides a flow chart of an exemplary method of operating a water heating appliance in accordance with an embodiment of the present disclosure.

### DETAILED DESCRIPTION OF THE INVENTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

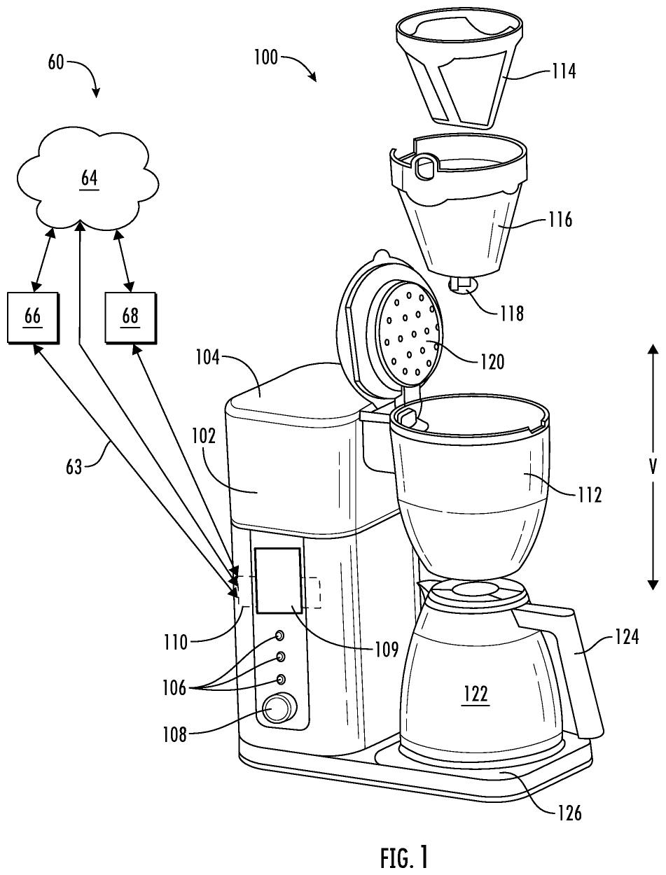

Turning to the figures, FIG. 1 provides a partially exploded perspective view of an exemplary water heating appliance 100 (which may be illustrated or described herein in terms of a coffee making appliance) according to one or more embodiments of the present subject matter. As illustrated in FIG. 1, the water heating appliance 100 defines a vertical direction V. In various exemplary embodiments, the water heating appliance 100 may include a water tank or reservoir 102 which is open at a top end thereof and is selectively enclosed by a reservoir lid 104. The reservoir lid 104 may be rotatably mounted, e.g., by one or more hinges, to the top end of the reservoir 102 to selectively rotate between a closed position (e.g., as illustrated in FIG. 1) where the reservoir 102, and in particular the open top end thereof, is enclosed by the lid 104 and an open position (not shown) permitting access to the reservoir 102, e.g., so that a user may fill the reservoir with water for heating or for coffee brewing. In other embodiments, the reservoir may be fluidly coupled to a water supply, for example a water utility or a personal well, and the reservoir provided with the water for heating or coffee brewing directly.

In some embodiments, the water heating appliance 100 may also include a filter 114, e.g., a mesh basket filter as in the example embodiment illustrated in FIG. 1, and a brew basket insert 116. As illustrated in FIG. 1, the filter 114 and the brew basket insert 116 are configured, e.g., sized and shaped, for nesting engagement with each other and with the brew basket 112. In particular, the filter 114 may be configured to fit within the brew basket insert 116 and the brew basket insert 116 may be configured to fit within the brew basket 112, e.g., with the filter 114 disposed within the brew basket insert 116 while the insert 116 is positioned within the brew basket 112. Thus, in some embodiments, the filter 114 may receive coffee grounds for brewing coffee and the filter 114, e.g., with grounds therein, may be received within the brew basket insert 116 while the brew basket insert 116 is received within the brew basket 112.

The water heating appliance 100 may further include a shower head 120 which is configured to be disposed above the brew basket 112 along the vertical direction V for providing a flow of water from the reservoir 102 to the brew basket 112, and in particular to the brew basket insert 116, the filter 114, and coffee grounds disposed therein, which are nested within the brew basket 112 as described above. In particular, the shower head 120 may receive the flow of water from the reservoir 102 via a pump (not shown). The shower head 120 is configured to provide a drip flow of water to the brew basket 112, e.g., the shower head 120 may include a plurality of outlets in order to form a slow, diffuse flow of water which is evenly distributed across the horizontal cross-sectional area of the brew basket 112. In additional embodiments, other suitable nozzle or spout configurations for providing and directing the flow of water from the reservoir 102 into the brew basket 112 may be provided as well as or instead of the shower head 120, such as a plurality of discrete nozzles (in contrast to the multiple outlets formed in the single unitary body of the shower head 120 as illustrated FIG. 1), among other possible example embodiments.

A carafe 122 may be removably positioned below the brew basket 112 along the vertical direction V. The water heating appliance 100 may include a hot plate 126 which is configured to provide thermal energy to the carafe 122 and contents thereof when the carafe 122 is positioned below the brew basket 112 and on top of the hot plate 126 as illustrated in FIG. 1. With the carafe 122 so positioned, the carafe 122 may receive a flow of liquid, e.g., heated water or coffee, from the brew basket 112 by gravity. The carafe 122 may include a handle 124 which a user may grasp to manipulate the carafe 122. The handle 124 may be formed of a thermally insulating material, e.g., plastic, and may thereby provide a cool, safe touch surface or surfaces for the user.

As may be seen in FIG. 1, the brew basket insert 116 may include a drip stop lever 118 which actuates a valve to open and thereby permit liquid flow from the brew basket 112 and/or from the brew basket insert 116 into the carafe 122. For example, the drip stop lever 118 may be configured to extend from the brew basket 112, e.g., below the brew basket 112 along the vertical direction V, when the brew basket insert 116 is received within the brew basket 112. Thus, when the carafe 122 is positioned below the brew basket 112 and aligned with the brew basket 112 to receive the liquid flow therefrom, the carafe 112 may engage the drip stop lever 118, e.g., may push the drip stop lever 118 upward along the vertical direction V, to thereby open the valve and permit liquid, e.g., coffee, to flow from the brew basket 112 into the carafe 122, e.g., by gravity as mentioned above.

It will be appreciated that the present subject matter can be used with other types of water heating household appliances as well, such as e.g., coffee makers that accept pods or packets of premeasured coffee instead of the illustrated brew basket 112, filter 114, and brew basket insert 116. The present subject matter may also be used with other water heating appliances such as electric tea kettles or the like. Consequently, the description set forth herein is not intended to limit the present subject matter in any aspect.

As shown in FIG. 1, in some embodiments, one or more selector inputs, such as buttons 106, one or more knobs 108, a touchpad, or touchscreen interfaces, etc., may be provided or mounted on the water heating appliance 100, e.g., on a control panel thereof and are in operable communication (e.g., electrically coupled or coupled through a wireless network band) with a processing device or controller 110, such as via one or more signal lines or shared communication busses. Selector inputs (e.g., buttons and knobs 106, 108) may be input devices useful in inputting information, such as location information (e.g., ZIP code, postal code, or geolocation coordinates) of the water heating appliance, or instructions to the controller 110.

In response to user manipulation of the selector inputs to input instructions, controller 110 operates the various components of water heating appliance 100 to execute selected cycles and features. The control panel may also include a display 109 to display messages regarding the operating conditions of the water heating appliance 100, feedback from user manipulation of the selector inputs, or maintenance or error messages. The controller 110 may also be in operable communication with various components of the water heating appliance, such as the hot plate 126, and electric heater element (not shown), as well as one or more sensors, e.g., thermocouples, thermistors, or other suitable temperature sensors. In turn, signals generated in controller 110 direct operation of such components in response to button or knob inputs 106, 108. As used herein, “processing device” or “controller” may refer to one or more microprocessors, microcontroller, ASICS, or semiconductor devices and is not restricted necessarily to a single element. The controller 110 may be programmed to operate water heating appliance 100 by executing instructions stored in memory (e.g., non-transitory media). The controller 110 may include, or be associated with, one or more memory elements such as RAM, ROM, or electrically erasable, programmable read only memory (EEPROM). In one embodiment, the processor executes programming instructions stored in memory. The memory may be a separate component from the processor or may be included onboard within the processor. For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller.

In embodiments, one or more of the programming instructions stored in memory and executed by the controller is a descaling operation. Water by nature includes various concentrations of dissolved minerals, for example calcium and magnesium. Under certain conditions, such as extended time or elevated temperature, the minerals can come out of solution and form deposits, sometimes called scale, on wetted surfaces. The scale can have negative effects on the performance of the water heating appliance 100. For example, scale can reduce or block the flow of water through various passages in the water heating appliance 100. Additionally, scale deposits may form on heating elements. The presence of scale on the heating elements insulates the heating elements and reduces the efficient heat energy transfer from the heating element to the water for instance. The insulating scale may also lead to overheating of the heating element as the insulation prevents heat from being removed from the heating elements. These conditions can lead to suboptimal performance of the water heating appliance and general user dissatisfaction.

The negative effect of the scale formation is proportional to the concentration of dissolved minerals in the water used. The concentration varies significantly by location and is generally measured as parts of dissolved minerals per million parts of water, with units of parts per million or PPM. In general, water hardness can be classified in three classes: soft, hard, and very hard. Some areas have a low concentration of dissolved minerals and are considered to have soft water with less than 150 PPM of dissolved minerals. Other areas have hard water which may be a concentration of minerals between 151 PPM and 275 PPM. Still others may have very hard water with a mineral concentration greater than 276 PPM. The various mineral concentrations influence how quickly and severely scale formation occurs.

To combat the formation of scale, a descaling operation may be programmed as a set of instructions into one or more of the memory elements associated with the controller 110. Descaling may be facilitated by the introduction of descaling agents to an amount of water to be cycled through the water heating appliance 100. The instructions for descaling may be executed by the controller 110 at a prescribed timed interval. It may be beneficial to adjust the time interval between descaling operations based on the class (soft, hard, very hard) of hard water in the location in which the water heating appliance 100 will operate.

As illustrated in the exemplary embodiment of FIG. 1, a schematic diagram of an external communication system 60 will be described according to an embodiment of the present subject matter. In general, external communication system 60 is configured for permitting interaction, data transfer, and other communications between water and among heating appliance 100, a network 64, and a user of such appliance through the consumer device 66. For example, this communication may be used to provide and receive information on brew water temperature, hot plate temperature, brew time, water volume provided to the brew basket, water volume remaining in the reservoir, strength of the brewed beverage, or other information as appropriate for improved performance of water heating appliance 100. Data transfer between the water heating appliance 100 and the network 64 or the consumer device 66 and the network 64 may also be used to establish the geographical area in which the water heating appliance 100 is located. This data may be communicated to, and stored at, the network 64 or remote server 68 and used to determine the water hardness, or an approximate water hardness, in the geographical area or location of the water heating appliance 100. This data can be used to approximate the hardness of the water that the water heating appliance 100 may be used with.

As discussed above, water heating appliance 100 may include a controller 110. The controller 110 may also include a clock for determining local time for programmed operation of the water heating appliance 100 or for monitoring the time the water heating appliance 100 is in an on condition, or the length of time a heating element is energized, or the time that has elapsed since a descaling operation was completed.

External communication system 60 permits controller 110 of water heating appliance 100 to communicate with external devices, for example consumer device 66, either directly through a direct link 63 or through a network 64. For example, a consumer may use a consumer device 66 linked to the controller 110 as an input device to communicate directly with water heating appliance 100. Alternatively, the water heating appliance 100 may include user interfaces for receiving such input. For example, consumer devices 66 may be directly or indirectly linked to the water heating appliance 100. That is, consumer device 66 may be in direct or indirect communication (i.e., linked) with the controller 110 of water heating appliance 100, e.g., directly through a local area network (LAN), Wi-Fi, Bluetooth, Zigbee, etc. or indirectly through network 64. In general, consumer device 66 may be any suitable device for providing or receiving communications or commands from a user. In this regard, consumer device 66 may include, for example, a personal smartphone, a tablet, a laptop computer, or another mobile device.

Consumer device 66 may be used to provide user input, similar to button or knob inputs 106, 108 to instruct controller 110 to operate various components of water heating appliance 100 to execute various cycles or features. A user may employ the consumer device 66, for example, to instruct the water heating appliance 100 to enter an on or off condition, to start or stop a brew cycle, or to adjust the temperature of the hot plate 126. The consumer device 66 may also serve as a display, similar to display screen 109, to provide a user with feedback from the controller 110 of the water heating appliance 100. Error messages and maintenance messages may also be displayed on the consumer device 66.

Consumer device 66 may also be used to input location information regarding the location of the water heating appliance 100. For example, a user may take advantage of information entry features of the consumer device 66 to enter the ZIP code or postal code of the location at which the water heating appliance 100 will be used. Such location information may be input to the controller 110 and communicated to the network 94 and stored in the network 94 or remote server 68. Additionally or alternatively GPS data from the consumer device may be communicated to the network 94 and stored in the network 94 or remote server 68. The consumer device 66 (or the button or knob inputs 106, 108) may be used to input specific details about the location for use of the water heating appliance. For example, water conditions at the location of use may impact the operation of the water heating appliance 100. Water hardness has a potentially negative influence on appliance performance was discussed above. To counter the effect of water hardness, some users may treat the water supply entering the location to remove excess dissolved minerals with a water softener. Such information may be useful when determining a descaling schedule and may be inputted to the controller 110, network 94, or remote server 68 using the consumer device 66 or selector inputs (button or knob inputs 106, 108).

In addition, a remote server 68 may be in communication with water heating appliance 100, or consumer device 66 through network 64. In this regard, for example, remote server 68 may be a cloud-based server 68, and is thus located at a distant location, such as in a separate state, country, etc. In general, communication between the remote server 68 and the network 64 or controller 110 may be carried via a network interface using any type of wireless connection, using a variety of communication protocols (e.g. TCP/IP, HTTP, SMTP, FTP), encodings or formats (e.g. HTML, XML), or protection schemes (e.g. VPN, secure HTTP, SSL).

In general, network 64 can be any type of communication network. For example, network 64 can include one or more of a wireless network, a wired network, a personal area network, a local area network, a wide area network, the internet, a cellular network, etc. According to an exemplary embodiment, consumer device 66 may communicate with a remote server 68 over network 64, such as the internet, to provide user inputs, historical data, transfer operating parameters, location data, or performance characteristics, etc. In addition, consumer device 66 and remote server 68 may communicate with water heating appliance 100 to communicate similar information.

Network 64 or remote server 68 may retrieve information from, for example, the internet, in response to input received from input devices such as button and knob 106, 108 or consumer device 66. For example, in response to location information received, the network 64 or remote server 68 may retrieve information regarding water quality associated with the input location. Water quality may include, among other things, water hardness as a measure of at least calcium and magnesium. Water quality information may be retrieved from look up tables stored in the network 64 or remoter server 68, or from sources accessible through the network 64.

External communication system 60 is described herein according to an exemplary embodiment of the present subject matter. However, it should be appreciated that the exemplary functions and configurations of external communication system 60 provided herein are used only as examples to facilitate description of aspects of the present subject matter. System configurations may vary, other communication devices may be used to communicate directly or indirectly with one or more water heating appliances, other communication protocols and steps may be implemented, etc. These variations and modifications are contemplated as within the scope of the present subject matter.

Now that the construction of water heating appliance 100 and the configuration of controller 110 according to exemplary embodiments have been presented, an exemplary method 200 of operating water heating appliance will be described. Although the discussion below refers to the exemplary method 200 of operating a water heating appliance 100, one skilled in the art will appreciate that the exemplary method 200 is applicable to the operation of a variety of other water heating appliances, such as coffee making appliances using prepackaged ground coffee in pods or packets. In exemplary embodiments, the various method steps as disclosed herein may be performed by controller 110 or a separate, dedicated controller.

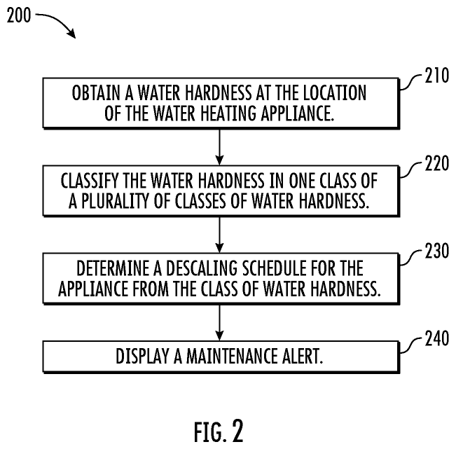

FIG. 2 illustrates an exemplary method 200 for operating a water heating appliance according to an exemplary embodiment of the present subject matter. Method 200 can be used to operate any suitable water heating appliances, such as the exemplary water heating appliance 100 of FIG. 1, or coffee making appliances, or electric kettles. In particular, controller 110 may be programmed or configured to implement method 200. Utilizing method 200, a descaling schedule can be established based on the water hardness in the location in which the water heating appliance 100 will be used. The schedule can be created according to specific local conditions. In particular, water hardness and the presence or existence of a water softening device in operation at the location of the water heating device can be taken into consideration by the controller to provide an optimal descaling schedule.

As illustrated in FIG. 2, the method 200 may include step 210 of obtaining the water hardness at the geographical location of the water heating appliance 100. The geographical area that the water heating appliance is located in may be obtained from one of user input information or data transfer from the appliance to a network. For example, a user may link a consumer device 66 to the appliance 100 as an input device and take advantage of the input capabilities of the consumer device in entering location information such as ZIP code or postal code for the location of the water hearting appliance 100. GPS data may also be input by the user.

Alternatively, the user may use the selector inputs such as the buttons and knobs 106, 108 on the appliance itself as an input device, with visual feedback possible on the display 109. As discussed above the user may input location information such as the ZIP code, postal code, or GPS data of the location in which the water heater appliance will be used.

In instances in which the ZIP code or postal code is not available, or not supplied, the Global Positioning System (GPS) location may be retrieved from a GPS-enabled consumer device, may be obtained from the network 64 to which the consumer device 66 or the water heating appliance 100 is connected, or may be a user input.

At 220, the input location information is used to determine the water hardness at that location. Water hardness information of many locations, indexed by ZIP code, postal code, or GPS coordinates are generally known and provided by free or subscription services. When the location information is obtained, it may be communicated to the network 64 or a remote server 68 via an external communication system 60. The network 64 or remote server 68 may access and store water hardness data for retrieval when needed. Water hardness data from previously accessed location information may be stored in look up tables or memory locations at the network 64 or remote server 68. In some cases, the network 64 or remote server 68 may not have data on a certain required location and may retrieve that data from a free or pay subscription data source through the network 64. Once retrieved, the data may be stored for future reference. The information on water hardness may be a single numerical value relating to, for example parts per million (PPM) of dissolved minerals, particularly calcium and magnesium. In other cases, the water hardness may be expressed in terms of a range of PPM values recorded or expected in the location. For example, a plurality of classes may be established, with class corresponding to a range of water hardness numerical values.

In some cases, a precise numerical value of water hardness is not required to determine descaling parameters. It may suffice to classify a water hardness value in one of a plurality of classes. At 220, the retrieved water hardness data may be classified in one of a plurality of classes. Each of the plurality of classes corresponds to a range of water hardness. For example, a water hardness of less than 150 PPM of dissolved minerals may be classified “soft,” a water hardness between 151 and 275 PPM may be classified “hard′” and a water hardness greater than 276 PPM may be classified “very hard.” Other numerical ranges or scales of hardness may be used for each classification, and more or fewer classifications may be used. The network 64 or remote server 68 may assign a classification of hardness to each location for which water data has been retrieved.

Each of the classifications (e.g., “soft,” “hard,” and “very hard”) may have associated with it a certain set of descaling parameters. To maintain the water heating appliance 100 in an acceptable operating condition, descaling operations may be performed at various intervals and under different conditions. At 240, the descaling schedule is determined at the network 64 or remote server 68 based on the water hardness classification in the area in which the water heating appliance will be operated. For example, a water hardness classified as “soft” may require descaling to be performed infrequently or with a short duration of the descaling process. In contrast, a water hardness classified as “very hard” may require frequent descaling with a long duration process.

Also at 220 a user may be queried on the input device, e.g., the consumer device 66 or display 109, to ascertain if a water softener device is present and in use at the location in which the water heating appliance will be operated. If the user input is in the negative or no response is provided, the water hardness determination proceeds as above. If the user input is in the affirmative, the water hardness for the location in question is assigned a nominal number and will be treated as if the water is “soft” as discussed below.

Upon determining an appropriate water hardness class or classification, at step 230, a descaling schedule is determined based on the water classification and at least in part on user input in response to the queries. For example, if the location of the appliance is known to be in an area with hard water, but the user input in response to the query regarding the presence and operation of a water softener is in the affirmative, the water hardness will be considered to be less than hard, for example it may be assigned a soft classification.

At 240, method 200 displays a maintenance alert or notification that a descaling operation is recommended. This notification corresponds to a descaling event according to the descaling schedule determined in 230. For example, the clock in the controller 110 may monitor the time between descaling operations. When the time interval determined at 240 is reached, controller 110 may signal an appropriate display to the input devices, e.g., display 109 or consumer device 66, alerting the user a descaling operation is recommended. In this manner, the descaling operation is performed at time intervals appropriate for the water characteristics (i.e., hardness) in the location.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method of operating a water heating appliance, the water heating appliance comprising a controller and an input device, the method comprising:
obtaining a water hardness at a location of the water heating appliance;
classifying the water hardness in a class of a plurality of classes; and
determining a descaling schedule for the water heating appliance from the class of the plurality of classes.

2. The method of claim 1, wherein obtaining the water hardness at the location of the water heating appliance comprises:
obtaining location information for the location of the water heating appliance, the location information obtained from one of user input on the input device and data transfer from the water heating appliance; and
determining the water hardness from the location information.

3. The method of claim 2, wherein the location information comprises one of a ZIP code, postal code, and GPS data for the location of the water heating appliance.

4. The method of claim 2, wherein determining the water hardness comprises:
communicating the location information by the controller to a network; and
retrieving, from the network, the water hardness for the location information from one of a look up table, the network, and a remote server.

5. The method of claim 1, wherein each of the plurality of classes corresponds to a preestablished water hardness range.

6. The method of claim 5, wherein the controller determines the descaling schedule from a prescribed schedule based on the class of the plurality of classes.

7. The method of claim 1, wherein obtaining the water hardness comprises:
querying a user on the input device; and
receiving user input in response to the query,
wherein the classification of the water hardness in one of the plurality of classes is based at least in part on the user input.

8. The method of claim 7, wherein the querying comprises a determination of a presence of a water softening device.

9. The method of claim 1, further comprising displaying a maintenance alert on the input device, the maintenance alert corresponding to a descaling event according to the descaling schedule.

10. The method of claim 1, wherein the water heating appliance is a coffee maker.

11. A water heating appliance comprising:
a controller; and
an input device;
wherein the controller is configured to:
obtain location information for a location of the water heating appliance, the location information obtained from one of user input on the input device and data transfer from the water heating appliance;
determining a water hardness from the location information;
classify the water hardness in one class of a plurality of classes; and
determine a descaling schedule for the water heating appliance from the one class of the plurality of classes.

12. The water heating appliance of claim 11, wherein the location information comprises one of a ZIP code, postal code, and GPS data for the location of the water heating appliance.

13. The water heating appliance of claim 11, wherein determining the water hardness comprises:
communicating the location information by the controller to a network; and
retrieving, from the network, the water hardness for the location information from one of a look up table, the network, and a remote server.

14. The water heating appliance of claim 11, wherein each class of the plurality of classes corresponds to a preestablished water hardness range.

15. The water heating appliance of claim 14, wherein the controller determines the descaling schedule from a prescribed schedule based on the class of the plurality of classes.

16. The water heating appliance of claim 11, wherein the controller is further configured to:
query a user on the input device;
receive a user input in response to the query; and
classify the water hardness in one of the plurality of classes based at least in part on the user input.

17. The water heating appliance of claim 16, wherein the query comprises a determination of an existence of a water softening device at the location of the water heating appliance.

18. The water heating appliance of claim 11, further configured to display a maintenance alert on the input device, the maintenance alert corresponding to a descaling event according to the descaling schedule.

19. A coffee making appliance comprising:
a controller; and
an input device;
wherein the controller is configured to:
obtain location information for a location of the coffee making appliance, the location information obtained from one of a user input on the input device and a data transfer from the coffee making appliance to a network;
determine a water hardness from the location information by retrieving, from the network, the water hardness for the location information from one of a look up table, the network, and a remote server;
classify the water hardness in one class of a plurality of classes;
determine a descaling schedule for the coffee making appliance from the one class of the plurality of classes; and
display a maintenance alert on the input device, the maintenance alert corresponding to a descaling event according to the descaling schedule.
